(19) United States
(12) Patent Application Publication
(10) Pub. No.: US 2026/0312315 A1
(43) Pub. Date: Oct. 8, 2026

(54) COMPACT, RELIABLE CONNECTOR FOR CABLE-TO-BOARD INTERCONNECTION

(71) Applicant: Amphenol Aorora Technology (Huizhou) Co., Ltd., Huizhou (CN)

(72) Inventors: Qi Han, Huizhou (CN); Xiaohong Zhu, Huizhou (CN)

(73) Assignee: Amphenol Aorora Technology (Huizhou) Co., Ltd., Huizhou (CN)

(21) Appl. No.: 19/637,121

(22) Filed: Apr. 2, 2026

(30) Foreign Application Priority Data
Apr. 3, 2025 (CN) 202520630808.1

(51) Int. Cl. H01R 12/79; H01R 12/70; H01R 12/72; H01R 13/506

(52) U.S. Cl. CPC H01R 12/79; H01R 12/7023; H01R 12/707; H01R 12/727; H01R 13/506

(57) ABSTRACT

Compact, reliable connectors for cable-to-board interconnection. An electronic system includes a first connector for mounting to a board, and a second connector for cable termination. The first connector includes a fixing member configured to secure the connector to a base supporting the board, thereby securing the connector to the board. The fixing member includes a first portion fixedly connected to the housing of the first connector, and a second portion configured to elastically engage a supporting arm of the base. The second connector includes a lever connected to its housing and extending across a mating portion and a rear portion. The lever is configured to engage a side feature of the first connector to secure the first and second connectors when mated. Such a configuration can reduce connector thickness and mating portion volume while maintaining connection strength, achieving lightweight cable-to-board interconnection with improved installation efficiency and reduced costs.

### CROSS-REFERENCE TO RELATED APPLICATIONS

This application claims priority to and the benefit of Chinese Patent Application No. 202520630808.1, filed on Apr. 3, 2025. The contents of this application are incorporated herein by reference in their entirety.

### TECHNICAL FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors. In other systems, it may be impractical to join two printed circuit boards by directly plugs on those printed circuit boards. For example, when the system is assembled, those printed circuit boards may be separated by too great a distance for a direct connection between connectors mounted to the printed circuit boards.

In some systems, connections between electronic assemblies may be made through cables. The cables may be terminated with connectors that mate with connectors mounted on a printed circuit board. In this way, connections between electronic assemblies may be made by plugging a connector that is part of a cable assembly into a board connector that is mounted to the printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine control unit, transmission control unit (TCUs), battery management system (BMS), cell sensing circuit (CSC), security systems, emissions control system, lighting control units, advanced driver assistance systems (ADAS), entertainment systems, navigation systems, and cameras. These electronic control units may be manufactured as separate assemblies. To simplify manufacture of an automobile, the assemblies may be connected via cables that are terminated with connectors that enable connections to mating board connectors terminating other cables or attached to printed circuit boards within the assemblies.

### SUMMARY

Aspects of the present disclosure relate to compact, reliable connectors for cable-to-board interconnection.

Some embodiments relate to an electrical connector. The electrical connector may comprise a housing comprises a top, a bottom, a side, a holder extending from the side, and a receiving space between the side and the holder; a plurality of terminals held by the housing, each of the plurality of terminals comprising a mating end configured to mate with complementary terminals of a mating connector, and a contact tail configured to mount to a circuit board; and a fixing member comprising a first portion disposed in the receiving space of the side of the housing, a second portion, a connecting portion between the first portion and the second portion and abutting against the holder of the side of the housing, the second portion extending beyond the bottom of the housing configured to fixedly connect to a base supporting the circuit board.

Optionally, the contact tail of each of the plurality of terminals is configured to surface mount on the circuit board.

Optionally, the housing comprises an arm extending from the side and around the second portion of the fixing member.

Optionally, the arm of the housing is configured to be inserted into a groove of the base.

Optionally, the connecting portion of the fixing member is C-shaped or U-shaped.

Optionally, the second portion of the fixing member comprises a spring arm protruding away from the side of the housing, and a barb protruding to a same extent as or beyond the spring arm, the barb disposed farther from the bottom of the housing than a bottom surface of the arm of the housing.

Optionally, the barb of the second portion of the fixing member is configured to engage a supporting arm of the base.

Optionally, the housing comprises a block protruding from the side toward the second portion of the fixing member, a gap between the block of the housing and the second portion of the fixing member, and a protrusion protruding from the side and closer to a mating face of the electrical connector than the block, the protrusion configured to engage a lever of the mating connector.

Some embodiments relate to an electronic system. The electronic system may comprise a base comprising a supporting arm; a circuit board configured to be disposed on the base; and an electrical connector comprising: a housing comprises a cavity, a plurality of terminals, each of the plurality of terminals comprising a mating end disposed in the cavity of the housing, and a contact tail mounted to the circuit board, and a fixing member comprising a first portion fixedly held by the housing, and a second portion configured to engage the supporting arm of the base.

Optionally, the supporting arm of the base comprises a groove; and the housing of the electrical connector comprises an arm extending outwardly and configured to be fixedly disposed in the groove of the supporting arm of the base.

Optionally, the second portion of the fixing member extends through a space between the arm and a side of the housing.

Optionally, the second portion of the fixing member comprises a barb disposed below the arm of the housing, the barb configured to fixedly engage the supporting arm of the base.

Optionally, the second portion of the fixing member comprises a spring arm disposed above the arm the housing, the spring arm configured to elastically engage the supporting arm of the base.

Optionally, the electrical connector is a first electrical connector comprising a first housing and a plurality of first terminals; and the electronic system comprises a second electrical connector, the second electrical connector comprising: a second housing comprising a mating portion and a rear portion, a plurality of second terminals, each of the plurality of second terminals comprising a second mating end held in the mating portion of the second housing and configured to engage a first mating end of a respective first terminal of the first electrical connector, and a second contact tail configured for cable termination, a first sealing member surrounding the mating portion of the second housing, and a second sealing member disposed in the second housing and configured to surround cable terminations.

Optionally, the first housing of the first electrical connector comprises a protrusion protruding outwardly from a side; and the second housing of the second electrical connector comprises a lever disposed outside the mating portion, the lever comprising an opening configured to receive the protrusion of the first electrical connector.

Some embodiments relate to a method of operating an electrical connector. The electrical connector may comprise a housing, a plurality of terminals each having a mating end and a contact tail, and a fixing member having a first portion fixedly held by the housing and a second portion elastically connected to the housing, the method comprising: surface mounting the contact tails of the plurality of terminals of the electrical connector on respective contact pads of a circuit board disposed on a base; and engaging the second portion of the fixing member with a supporting arm of the base so as to secure the connector to the circuit board.

Optionally, engaging the second portion of the fixing member with the supporting arm of the base comprises: inserting a barb of the second portion of the fixing member into a slit of the supporting arm of the base.

Optionally, engaging the second portion of the fixing member with the supporting arm of the base comprises: deforming a spring arm of the second portion of the fixing member with the supporting arm of the base.

Optionally, the method comprises disposing an arm of the housing that is around the second portion of the fixing member into a complementary-shaped groove of the supporting arm of the base.

Optionally, the method comprises inserting a mating portion of a cable connector into the housing of the connector, the cable connector comprising a housing having a mating portion and a rear portion, and a lever connected to the housing and extending across the mating portion and the rear portion of the housing, wherein inserting the mating portion of the cable connector comprises engaging the lever with a protrusion protruding outwardly from a side of the connector.

Some embodiments relate to a connector disposed on a circuit board. The connector may comprise a first housing and a fixing member, wherein: the first housing comprises a pair of sides oppositely disposed in a horizontal direction, and a first end and a second end oppositely disposed in a longitudinal direction, the side comprising a holder and a receiving space; and the fixing member comprises a connecting portion, a first portion and a second portion disposed at opposite sides of the connecting portion, the first portion inserted into the receiving space, the connecting portion abutting against the holder, the second portion elastically connected to the side, and the second portion comprising a barb, the second portion configured to snap-connect to a supporting arm of a base where the circuit board is mounted through the barb, thereby connecting the connector and the base.

Optionally, the first housing comprises an arm on the side and extending towards the base, the arm configured to be inserted into a groove of the base.

Optionally, the first housing comprises a bottom and a top disposed along a height direction; the bottom, the top, the second end and the sides bound a cavity with an opening; the barb is disposed on a side of the second portion away from the cavity; the second portion is bent at its end to form a guiding portion disposed on a side of the second portion adjacent to the cavity; and the supporting arm comprises a slit, and the barb is snap-connected into the slit.

Optionally, the connector comprises a first terminal, with one end of the first terminal soldered to the circuit board, and the other end extending from the second end into the cavity.

Optionally, the connecting portion is a C-shaped or U-shaped structure, and a length of the second portion is greater than a length of the first portion; the second portion comprises a spring arm, and a protruding height of the spring arm is equal to or less than a protruding height of the barb; and a distance between the barb and the bottom is greater than a distance between a bottom surface of the arm and the bottom.

Optionally, the side comprises a block protruding towards the second portion, and a gap between the block and the second portion.

Some embodiments relate to a connector assembly comprising a connector described herein, and a mating connector mated with the connector through the first end.

Optionally, the mating connector comprises: a second housing comprising a pair of sides oppositely disposed in the horizontal direction, and a mating end and a rear end oppositely disposed in the longitudinal direction, the rear end configured for connecting to a cable; a first sealing member surrounding the mating end; and a second sealing member wrapping the cable and connected to the rear end in an embedding manner.

Optionally, the side comprises a lever disposed outside the mating end and comprising an opening; and the side comprises, near the first end, a protrusion configured to be snap-connected into the opening.

Optionally, the mating connector further comprises a second terminal configured to electrically connect with the first terminal.

These techniques may be used alone or in any suitable combination. The foregoing summaries are provided by way of illustration and are not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1 is a perspective view of a system comprising a first connector mounted to a circuit board and fixed to a base, according to some embodiments.

FIG. 2 is an exploded perspective view of the system of FIG. 1.

FIG. 3 is an enlarged perspective view of a region of the first connector shown in FIG. 1 within a circle marked “A” in FIG. 2, with a fixing member removed.

FIG. 4 is a perspective view of the first connector shown in FIG. 1.

FIG. 5 is a cross-sectional view of the first connector of FIG. 4 taken along a line marked “B-B” in FIG. 4.

FIG. 6 is a perspective view of first terminals of the first connector of FIG. 4.

FIG. 7 is an elevation view of the fixing member of the first connector of FIG. 4.

FIG. 8 is an enlarged perspective view of the region of the first connector shown in FIG. 1 within the circle marked “A” in FIG. 2.

FIG. 9 is a perspective view of the system of FIG. 1, showing a second connector mated with the first connector, according to some embodiments.

FIG. 10 is a perspective view of separated first connector and second connector shown in FIG. 9.

FIG. 11 is a cross-sectional view of the system of FIG. 9, taken along a line marked “C-C” in FIG. 9.

FIG. 12 is an enlarged perspective view of a region of the system of FIG. 9 within a circle marked “D” in FIG. 10.

FIG. 13 is a cross-sectional perspective view of mated first connector and second connector shown in FIG. 9.

FIG. 14 is an exploded perspective view of the second connector shown in FIG. 9.

List of Reference Signs: 100 first connector; 1 first housing; 11 side; 111 holder; 112 receiving space; 113 block; 114 gap; 115 protrusion; 116 arm; 12 first end; 13 second end; 14 bottom; 15 top; 16 cavity; 2 fixing member; 21 connecting portion; 22 first portion; 23 second portion; 231 barb; 232 guiding portion; 233 spring arm; 3 first terminal; 200 circuit board; 300 base; 301 supporting arm; 3011 slit; 302 groove; 400 connector assembly; 4 second connector; 41 second housing; 411 side; 4111 lever; 41111 opening; 41112 button; 4112 rib; 412 mating portion; 413 rear portion; 4131 cable; 42 first sealing member; 43 second sealing member; 44 second terminal; 441 hole; 45 terminal lock.

### DETAILED DESCRIPTION

The inventors have recognized and appreciated techniques for making compact, reliable connectors for cable-to-board interconnection. Such connectors may be used in a harsh environment such as one presented by an automobile. For example, the connector may be used to connect a battery management system (BMS) and cell sensing circuit (CSC) in automobiles.

The inventors have recognized and appreciated that while using flexible cable instead of cable harnesses can meet the requirements for lightweight equipment with high integration. Price-sensitive sectors, such as energy storage systems and low-end automobiles, still adopt more economical cable connections. Conventionally, cables are connected to cable-to-board connectors by crimping, which increases the volume and height of the mating portion of the connectors, compared to flexible cable solutions, thereby hindering further improvements in system weight reduction and integration. Further, conventional connectors often use screw or rivet connections at the board-side interface, which require large installation space and involve cumbersome installation and removal processes. Alternatively, the tab-type connection, in which fixing tabs are inserted and bent for fixation, typically provide limited connection strength, and the solder spots between the connector and the circuit board may be subjected to significant localized stresses under external loads.

Techniques describe herein provide a board connector and a cable connector configured to mate with each other. By inserting a fixing member into a housing of the board connector and snap-connecting the fixing member to a base, the thickness of the connectors and the volumes of connector mating portions can be reduced while maintaining sufficient connection strength, thereby achieving lightweight and highly integrated cable-to-board connector configurations using cable solutions. In addition, installation and removal efficiency may be improved, and production and maintenance costs may be reduced.

In some embodiments, a first portion of the fixing member may be inserted into a receiving space of the housing of the board connector, and a connecting portion of the fixing member may abut against a holder of the housing of the board connector, such that the fixing member is secured to the first housing. The connector may be fixed to a circuit board via a barb of the second portion of the fixing member. The barb may snap-connect to a supporting arm of a base. Compared with conventional cable-to-board connectors, such configurations can reduce the thicknesses of the connectors and the volumes of the mating portions while maintaining connection strength, thereby achieving a lightweight effect.

In some embodiments, by adopting a fixing method including an elastically arranged second portion of the fixing member and a snap-connection between the barb and the supporting arm of the base, the connectors can achieve improved installation and removal efficiency, as well as reduced production and maintenance costs, while maintaining reliable performance, as compared to conventional connectors using screws, rivets, or tab solutions.

In some embodiments, when using cables to connect to the circuit board, the connector assembly can achieve a level of integration comparable to that of flexible cable solutions, thereby addressing limitations in size and thickness typically associated with conventional cable-based cable solutions.

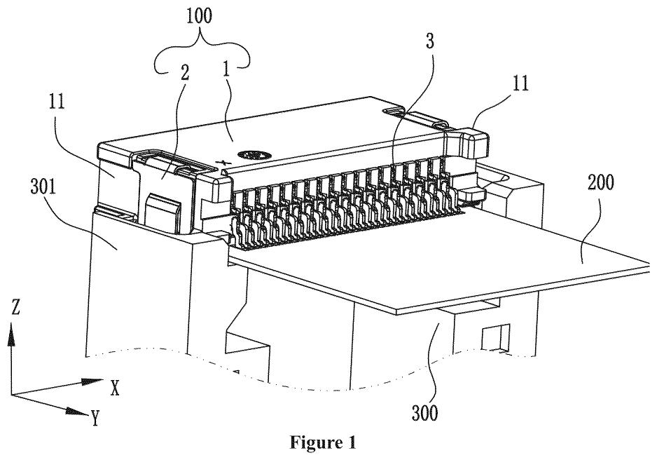

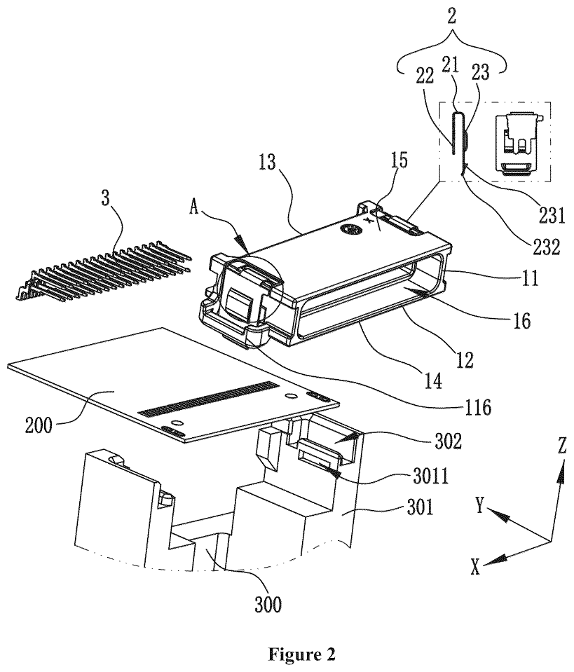

Referring to FIG. 1 and FIG. 2, a system may include a first connector 100. The first connector 100 comprises a first housing 1 and a fixing member 2. The first connector 100 is stably fixed to the circuit board 200 by inserting one side of the fixing member 2 into the first housing 1 and snap-connecting the other side with a base 300 supporting the circuit board 200.

To facilitate subsequent description and understanding, the movement direction along the X-axis in the figures may be referred to as the horizontal direction, the movement direction along the Y-axis may be referred to as the longitudinal direction, and the movement direction along the Z-axis may be referred to as the height direction or the up-down direction.

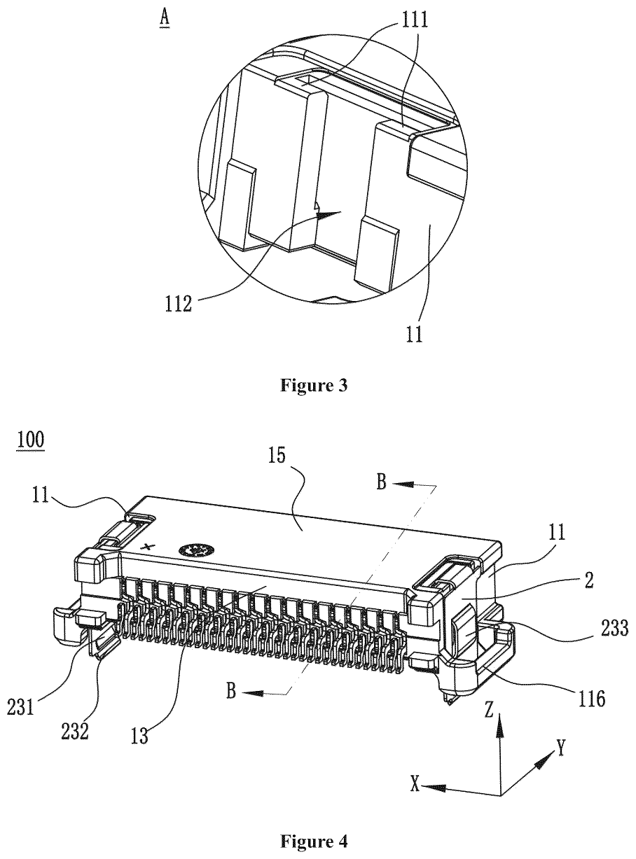

Referring to FIG. 1 to FIG. 3, the first housing 1 comprises a top 15, a bottom 14, a pair of sides 11 oppositely disposed in the horizontal direction, and a first end 12 and a second end 13 oppositely disposed in the longitudinal direction. The side 11 comprises a holder 111 extending from the side 11, and a receiving space 112 between the side 11 and the holder 111.

In the illustrated example, there are two fixing members 2, each comprising a connecting portion 21 and a first portion 22 and a second portion 23 disposed at opposite sides of the connecting portion 21. The first portion 22 is disposed in the receiving space 112 of the side 11 of the first housing 1. The connecting portion 21 is between the first portion 22 and the second portion 23 and abuts against the holder 111 of the side 11 of the first housing 1. The second portion 23 is elastically connected to the side 11, extends beyond the bottom 14 of the first housing 1, and is configured to fixedly connect to the base 300 supporting the circuit board 200. The second portion 23 comprises a barb 231.

The circuit board 200 is disposed on the base 300, and the base 300 comprises a supporting arm 301. The second portion 23 is snap-connected to the supporting arm 301 through the barb 231, thereby connecting the first connector 100 and the base 300 together.

The circuit board 200 is sandwiched between the first connector 100 and the base 300 like the middle layer of a “sandwich”, ensuring the connection strength between the first connector 100 and the circuit board 200. Such a configuration enables that, when the first connector 100 is mated or un-mated with a matching cable connector, the soldering connection between the first connector 100 and the circuit board 200 would not be affected by the force generated during the mating/un-mating process.

Compared with existing cable connectors, the height of the first connector 100 on the circuit board 200 and the volume of the mating portion can be made smaller in this embodiment, without requiring the larger volume for screw connection and rivet connection solutions to accommodate the space for the connection structure. Compared with existing tab-type fixing solutions, the first connector 100 described in this embodiment has enhanced connection strength, ensuring good stability of the electrical connection between the cable and the circuit board 200.

In addition to the smaller and thinner mating portion, by virtue of the fixing member 2 being inserted and fixed to the first housing 1, the fixing member 2 forms an integration with the first housing 1; and, by virtue of the barb 231 being snap-connected to the supporting arm 301, the first connector 100, the circuit board 200, and the base 300 can be quickly assembled or disassembled. Compared with fixing solutions using screws and other fasteners, the efficiency is higher and the production cost is lower. Compared with tab-type fixing methods, the replacement purpose can be achieved with reduced risk of damaging the structure of the first connector 100 in case of maintenance and replacement, significantly reducing maintenance costs.

The first housing 1 comprises an arm 116 on the side 11 and extending towards the base 300. The arm 116 extends from the side 11 and around the second portion 23 of the fixing member 2. The base 300 comprises a groove 302, and the arm 116 is configured to be inserted into the groove 302 of the base 300. In the illustrated example, the arm 116 is a “Ø-shaped” structure which is configured to surround the periphery of the second portion 23, and a portion of the groove 302 matches the shape of the “Ø-shaped” arm 116. Through the insertion and cooperation of the arm 116 and the groove 302, the positions in the horizontal and longitudinal directions of the first housing 1 and the base 300 are precise. This ensures that the snap-connection between the barb 231 and the supporting arm 301 meets the design requirements and the consistency of mass production. It should be appreciated that the Ø-shaped” structure is only one of the optimal solutions; in other embodiments, the arm 116 can also be a “T-shaped” or an “L-shaped” structure.

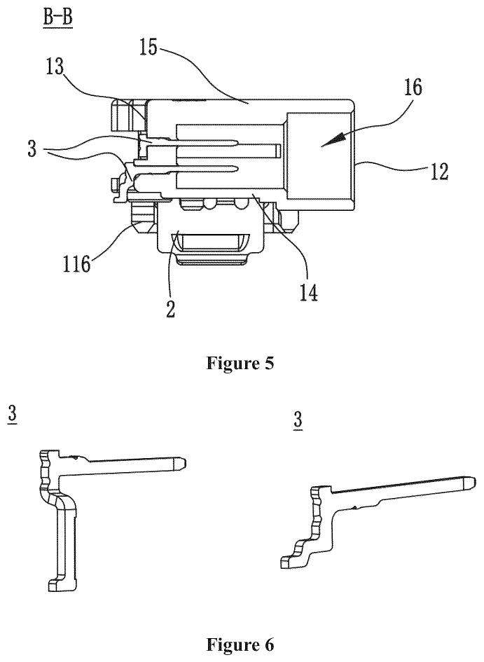

With reference to FIGS. 1-3, and further to FIGS. 4-5, in some embodiments, the first housing 1 comprises a bottom 14 and a top 15 disposed along the height direction. The bottom 14, the top 15, the second end 13, and the sides 11 on both sides bound a cavity 16 with an opening. The opening of the cavity 16 communicates with the first end 12, forming a structure for insertion. Therefore, in a practical arrangement, the first end 12 is often disposed at the edge of the circuit board 200, which facilitates the mating cooperation between the first connector 100 and the second connector in case of the cable connection.

In the illustrated example, the barb 231 is disposed on a side of the second portion 23 away from the cavity 16. The second portion 23 is bent at its end to form a guiding portion 232, and the guiding portion 232 is located at a side of the second portion 23 adjacent to the cavity 16. The supporting arm 301 comprises a slit 3011, and the barb 231 is configured to engage the supporting arm 301 by being snap-connected into the slit 3011. As shown in FIG. 2, the slit 3011 is disposed on the inner side of the supporting arm 301. The barb 231 may be shaped as an “inverted triangle” avoidance structure on the side of the second portion 23 away from the cavity 16, so that the barb 231 moves along with the elastic second portion 23 to avoid the supporting arm 301 and enter the slit 3011. Moreover, early avoidance of the second portion 23 can be achieved by providing the guiding portion 232. During the insertion process, the guiding portion 232 guides the second portion 23, such that the barb 231 is snap-connected into the slit 3011 without pressing the second portion 23 with a finger.

In the illustrated example, the first connector 100 comprises first terminals 3. Each first terminal 3 comprises a mating end configured to mate with complementary terminals of a mating connector 4, and a contact tail configured to mount to the circuit board 200. In the illustrated example, the contact tail of each of the plurality of first terminals 3 is configured to surface mount on the circuit board 200. One end of each first terminal 3 is soldered to the circuit board 200, and the other end extends from the second end 13 into the cavity 16, with the mating end disposed in the cavity 16 of the first housing 1. When a mating connector is inserted into the cavity 16, a cable may be electrically connected to the circuit board 200 indirectly through the first terminal 3, achieving the electrical connection effect of the first connector 100. To further reduce the height and overall volume of the first connector 100, in the illustrated example, there are two rows of first terminals 3, an upper row and a lower row. The soldering positions of the upper row of first terminals 3 and the lower row of first terminals 3 on the circuit board 200 are staggered, arranged in a “straight line”. To achieve the staggering and increase the creepage distance, the first terminals 3 in the upper and lower rows have bends at different angles at the second end 13. In FIG. 6, the left side shows the first terminals 3 of the upper row, and the right side shows the first terminals 3 of the lower row.

The connecting portion 21 may have a C-shaped or U-shaped structure, and a length of the second portion 23 is greater than a length of the first portion 22. In the illustrated example, the opening of the connecting portion 21 faces downward, ensuring that the fixing member 2 accurately abuts against the holder 111, thereby ensuring accurate and stable snap-connection between the barb 231 and the slit 3011. As shown in FIG. 7, the second portion 23 comprises a spring arm 233 protruding away from the side 11 of the first housing 1, and a protruding height of the spring arm 233 is equal to or less than a protruding height of the barb 231, such that the barb 231 protrudes to a same extent as or beyond the spring arm 233. The barb 231 is disposed farther from the bottom 14 of the first housing 1 than a bottom surface of the arm 116 of the first housing 1. With the spring arm 233, the position of the second portion 23 becomes more obvious, such that the second portion 23 can be quickly found and pressed. In practical applications, to ensure the stable and effective snap-connection of the barb 231, the slit 3011 should have sufficient depth to accommodate the barb 231, such that the barb 231 can enter the space of the slit 3011. With the spring arm 233, and with the protruding height of the spring arm 233 being equal to or less than the protruding height of the barb 231, it is ensured that the barb 231 remains securely latched after installation, and the risk of disengaging the barb 231 from the slit 3011 due to misoperation is reduced.

In the illustrated example, a distance between the barb 231 and the bottom 14 is greater than a distance between a bottom surface of the arm 116 and the bottom 14. In the height direction, when the barb 231 is not snap-connected to the slit 3011, the arm 116 has already entered the groove 302, with achieving a connection effect of positioning first, then locking. Furthermore, with the distance between the barb 231 and the bottom 14 being greater than the distance between the bottom surface of the arm 116 and the bottom 14, the spacing between the slit 3011 and the groove 302 is sufficient, thereby also ensuring the structural strength of the supporting arm 301 at this location. In some embodiments, the second portion 23 of the fixing member 2 extends through a space between the arm 116 and the side 11 of the first housing 1. The barb 231 is disposed below the arm 116 of the first housing 1 and is configured to fixedly engage the supporting arm 301 of the base 300. The spring arm 233 is disposed above the arm 116 of the first housing 1 and is configured to elastically engage the supporting arm 301 of the base 300.

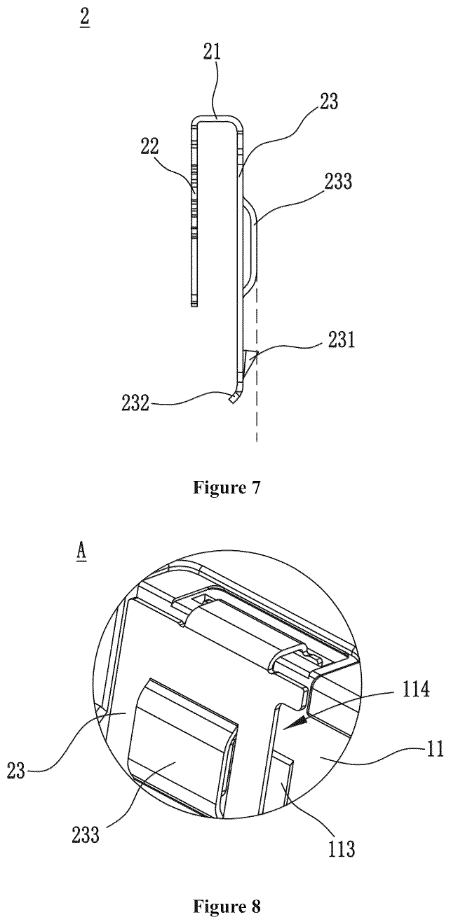

As shown in FIG. 8, to ensure a smooth installation or disassembly by an operator, the second portion 23 does not lose its elasticity due to excessive deformation. The side 11 comprises a block 113 protruding from the side 11 toward the second portion 23 of the fixing member 1. A gap 114 is between the block 113 of the first housing 1 and the second portion 23 of the fixing member 2. The side 11 further comprises a protrusion 115 protruding from the side 11 and closer to a mating face of the first connector 100 than the block 113, the protrusion 115 configured to engage a lever 4111 of the mating connector 4. When the operator applies pressure to the second portion 23, the barb 231 may gradually disengage from the supporting arm 301 during the elastic deformation of the second portion 23. Generally, before the second portion 23 abuts against the block 113, the barb 231 has already disengaged from the supporting arm 301, and the first connector 100 can then be separated from the circuit board 200 and the base 300.

In some embodiments, the first portion 22 is inserted into the receiving space 112 and the connecting portion 21 abuts against the holder 111, such that the fixing member 2 is fixed to the first housing 1, and the first connector 100 is fixed to the circuit board 200 by the barb 231 snap-connecting to the supporting arm 301. Compared with existing connectors, the thickness of the first connector 100 and the volume of the mating portion are reduced under the premise of ensuring connection strength, achieving a lightweight effect for wire-to-board connectors in case of cable solution.

In some embodiments, adopting a fixing method with the elastically arranged second portion 23 and a snap-connection of the barb 231 to the supporting arm 301, the first connector 100 has higher installation and disassembly efficiency, and lower production and maintenance costs while ensuring the usage effect, compared to existing connectors using screws, rivets, or tab solutions.

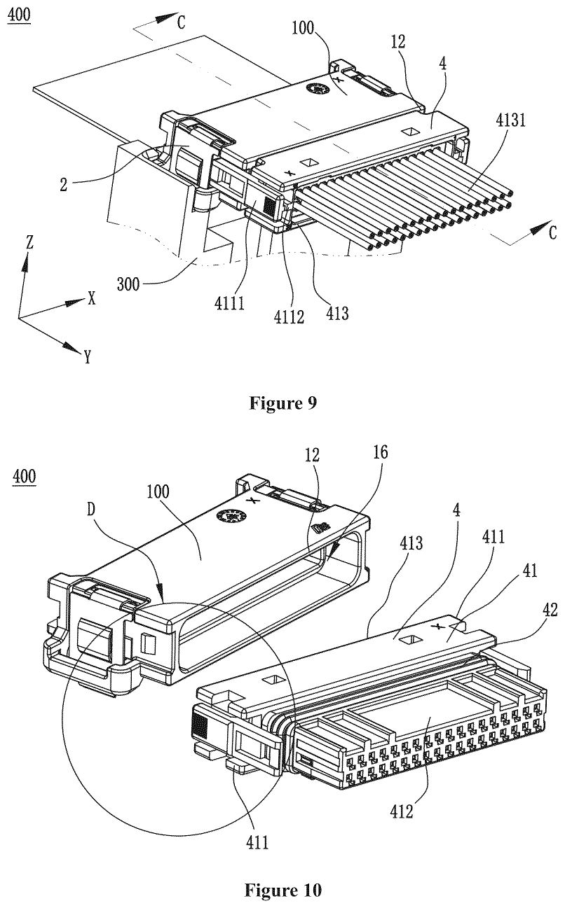

With reference to FIGS. 1-8 and further to FIGS. 9-12, a connector assembly 400 may comprise the first connector 100 and a second connector 4. The second connector 4 may be mated with the first connector 100 through the first end 12. One end of the second connector 4 is connected to a cable 4131, and the other end is mated with the first connector 100, thereby achieving electrical connection between the cable 4131 and the circuit board 200.

In the illustrated example, the second connector 4 comprises a second housing 41, a first sealing member 42, and a second sealing member 43. The second housing 41 comprises a pair of sides 411 oppositely disposed in the horizontal direction, and a mating portion 412 and a rear portion 413 oppositely disposed in the longitudinal direction. The rear portion 413 is connected to the cable 4131. The first sealing member 42 is disposed surrounding the mating portion 412 of the second housing 41, and the second sealing member 43 is disposed in the second housing 41 and configured to surround cable terminations by wrapping the cable 4131 and be connected to the rear portion 413 in an embedding manner.

In use, the mating portion 412 is inserted into the first end 12, realizing the connection between the second connector 4 and the first connector 100. After insertion, the first sealing member 42 has its outer side abutting and sealing against the inner surface of the cavity 16, and its inner side wrapping and sealing the outer surface of the mating portion 412, thereby isolating the connection position between the second connector 4 and the first connector 100 from the external space, preventing possible liquid ingress and avoiding short-circuit risks. Providing the second sealing member 43 at the connection position between the rear portion 413 and the cable 4131 further prevents liquid from seeping into the cavity 16 from the location of the cable 4131.

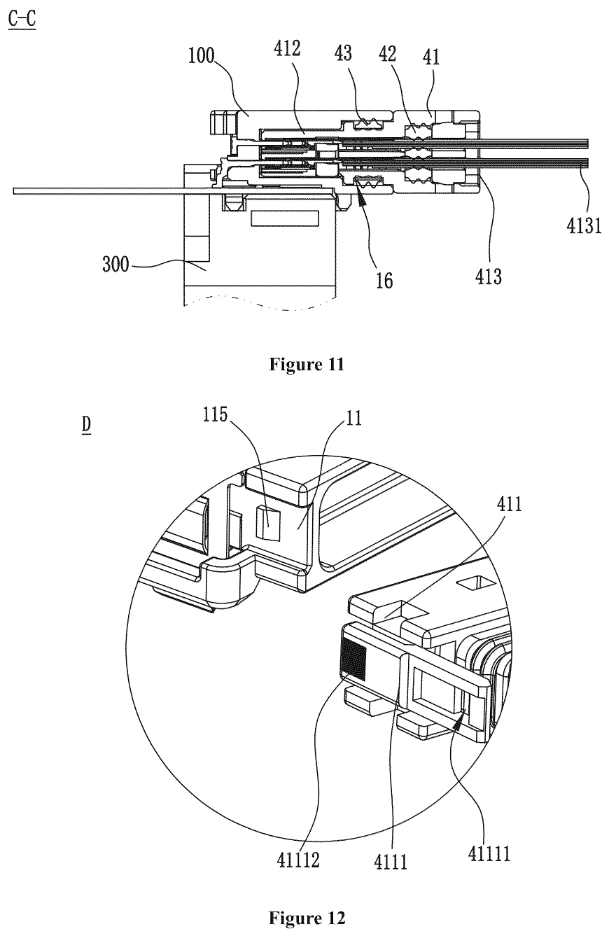

Further, with reference to FIGS. 9-11 and further to FIG. 12, the side 411 comprises a lever 4111 disposed outside the mating portion 412. The lever 4111 comprises an opening 41111 configured to receive the protrusion 115 of the first connector 100. The side 11 of the first housing 1 is provided, near the first end 12, with the protrusion 115 protruding outwardly from the side 11, and the protrusion 115 is configured to be snap-connected into the opening 41111. When the mating portion 412 is inserted into the cavity 16 of the first end 12, the second connector 4 is locked and fixed to the first connector 100 through the snap-connection between the lever 4111 and the protrusion 115 on the first connector 100.

In the illustrated example, the lever 4111 has a symmetrical “seesaw” structure. Its middle part is connected to the side 411, forming a fulcrum. The side facing the rear portion 413 comprises a button 41112, and the side facing the side 11 comprises the opening 41111. When the mating portion 412 is inserted into the first end 12, the protrusion 115 lifts the edge of the opening 41111 and then falls into the opening 41111. To unlock and disengage the second connector 4 and the first connector 100, press the button 41112 while pulling the first connector 100 and the second connector 4 apart in opposite directions, and the opening 41111 and the protrusion 115 disengage, and then the mating portion 412 can be separated from the first end 12.

In some embodiments, considering that the second housing 41 is mostly made of materials with good insulation properties, such as rubber or plastic, it has a relatively low maximum allowable elastic deformation. To prevent the lever 4111 from breaking due to exceeding its limits during assembling, the side 411 is provided, on the side facing the button 41112, with a rib 4112. As shown in FIG. 9, when unlocking the second connector 4 and the first connector 100, press the button 41112 until it abuts against the rib 4112, and the lever 4111 will not exceed the elastic deformation limit of its material, thereby improving the service life of the lever 4111.

In some embodiments, with the connector assembly provided by the present disclosure, there is a high integration effect close to that of flexible cable solutions when using cables to connect to the circuit board, solving the problem that conventional connector assembly cannot be made small and thin in case of adopting cable solutions.

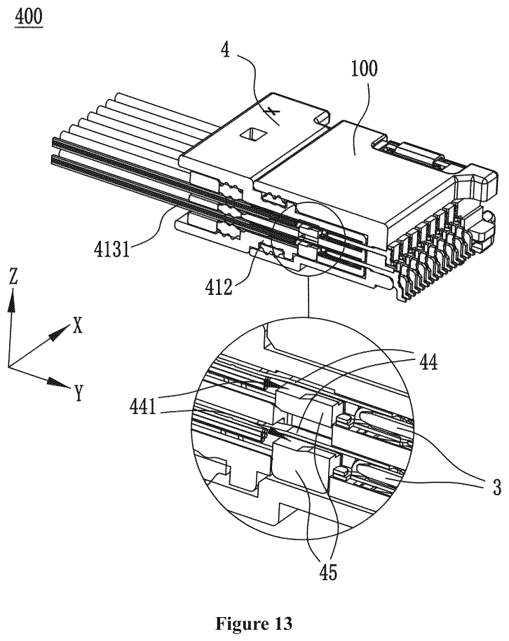

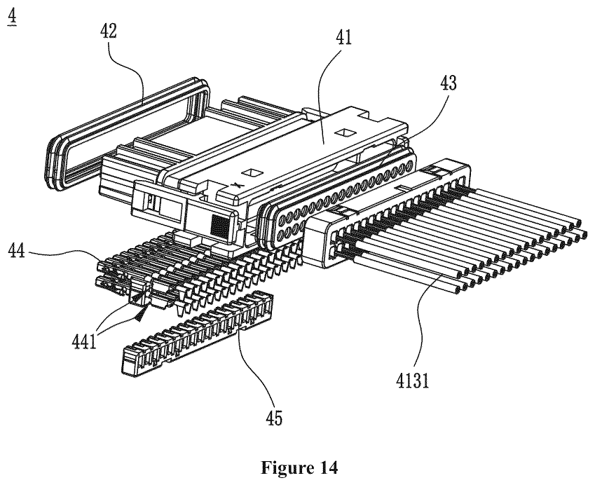

With reference to FIGS. 1-12 and further to FIGS. 13-14, the second connector 4 comprises second terminals 44. Each second terminal 44 comprises a second mating end held in the mating portion 412 of the second housing 41 and configured to engage a first mating end of a respective first terminal 3 of the first connector 100, and a second contact tail configured for cable termination. One end of the first terminal 3 is soldered to the circuit board 200 to achieve electrical connection, and the other end is in contact with the second terminal 44. Each second terminal 44 is electrically connected to a respective cable 4131 inside the mating portion 412. Through the electrical contact between the first terminal 3 and the second terminal 44, a separable connection between the cable 4131 and the circuit board 200 is achieved.

In some embodiments, to further reduce the height of the first connector 100 and the second connector 4, the second terminal 44 is mated with the first terminal 3 by a lateral point contact, reducing the size of the second terminal 44 in the height direction during molding.

In some embodiments, the second connector 4 comprises a terminal lock 45, and each second terminal 44 comprises a hole 441 matching the terminal lock 45. On a row of second terminals 44, the terminal lock 45 is inserted into the corresponding holes 441, achieving a locking and fixing effect for the second terminals 44 inside the second housing 41. Compared to existing solutions where the second terminal 44 comprises an elastic sheet structure and the second housing 41 comprises a latch hole, the height and overall volume can be further reduced, achieving a higher wiring density for the connector assembly 400.

In some embodiments, a method of operating an electrical connector may comprise surface mounting the contact tails of the plurality of first terminals 3 of the first connector 100 on respective contact pads of the circuit board 200 disposed on the base 300, and engaging the second portion 23 of the fixing member 2 with the supporting arm 301 of the base 300 so as to secure the first connector 100 to the circuit board 200. Engaging the second portion 23 of the fixing member 2 with the supporting arm 301 of the base 300 may comprise inserting the barb 231 of the second portion 23 of the fixing member 2 into the slit 3011 of the supporting arm 301 of the base 300. Engaging the second portion 23 of the fixing member 2 with the supporting arm 301 of the base 300 may comprise deforming the spring arm 233 of the second portion 23 of the fixing member 2 with the supporting arm 301 of the base 300. achieving a higher wiring density for the connector assembly 400.

In some embodiments, the method may comprise disposing the arm 116 of the first housing 1 that is around the second portion 23 of the fixing member 2 into a complementary-shaped groove 302 of the supporting arm 301 of the base 300. The method may comprise inserting the mating portion 412 of the second connector 4 (which may be referred to as a cable connector) into the first housing 1 of the first connector 100, wherein inserting the mating portion 412 of the second connector 4 comprises engaging the lever 4111 with the protrusion 115 protruding outwardly from the side 11 of the first connector 100.

Various aspects are described in this disclosure, which include, but are not limited to, the following aspects:

1. An electrical connector comprising: a housing (e.g., 1) comprises a top (e.g., 15), a bottom (e.g., 14), a side (e.g., 11), a holder (e.g., 111) extending from the side (e.g., 11), and a receiving space (e.g., 112) between the side (e.g., 11) and the holder (e.g., 111); a plurality of terminals (e.g., 3) held by the housing (e.g., 1), each of the plurality of terminals (e.g., 3) comprising a mating end configured to mate with complementary terminals of a mating connector (e.g., 4), and a contact tail configured to mount to a circuit board (e.g., 200); and a fixing member (e.g., 2) comprising a first portion (e.g., 22) disposed in the receiving space (e.g., 112) of the side (e.g., 11) of the housing (e.g., 1), a second portion (e.g., 23), a connecting portion (e.g., 21) between the first portion (e.g., 22) and the second portion (e.g., 23) and abutting against the holder (e.g., 111) of the side (e.g., 11) of the housing (e.g., 1), the second portion (e.g., 23) extending beyond the bottom (e.g., 14) of the housing (e.g., 1) and configured to fixedly connect to a base (e.g., 300) supporting the circuit board (e.g., 200).

2. The electrical connector of aspect 1 or any other aspect, wherein: the contact tail of each of the plurality of terminals (e.g., 3) is configured to surface mount on the circuit board (e.g., 200).

3. The electrical connector of aspect 1 or any other aspect, wherein: the housing (e.g., 1) comprises an arm (e.g., 116) extending from the side (e.g., 11) and around the second portion (e.g., 23) of the fixing member (e.g., 2).

4. The electrical connector of aspect 3 or any other aspect, wherein: the arm (e.g., 116) of the housing (e.g., 1) is configured to be inserted into a groove (e.g., 302) of the base (e.g., 300).

5. The electrical connector of aspect 3 or any other aspect, wherein: the connecting portion (e.g., 21) of the fixing member (e.g., 2) is C-shaped or U-shaped.

6. The electrical connector of aspect 5 or any other aspect, wherein: the second portion (e.g., 23) of the fixing member (e.g., 2) comprises a spring arm (e.g., 233) protruding away from the side (e.g., 11) of the housing (e.g., 1), and a barb (e.g., 231) protruding to a same extent as or beyond the spring arm (e.g., 233), the barb (e.g., 231) disposed farther from the bottom (e.g., 14) of the housing (e.g., 1) than a bottom surface of the arm (e.g., 116) of the housing (e.g., 1).

7. The electrical connector of aspect 6 or any other aspect, wherein: the barb (e.g., 231) of the second portion (e.g., 23) of the fixing member (e.g., 2) is configured to engage a supporting arm (e.g., 301) of the base (e.g., 300).

8. The electrical connector of aspect 4 or any other aspect, wherein: the housing (e.g., 1) comprises a block (e.g., 113) protruding from the side (e.g., 11) toward the second portion (e.g., 23) of the fixing member (e.g., 2), a gap (e.g., 114) between the block (e.g., 113) of the housing (e.g., 1) and the second portion (e.g., 23) of the fixing member (e.g., 2), and a protrusion (e.g., 115) protruding from the side (e.g., 11) and closer to a mating face of the electrical connector than the block (e.g., 113), the protrusion (e.g., 115) configured to engage a lever (e.g., 4111) of the mating connector.

9. An electronic system comprising: a base (e.g., 300) comprising a supporting arm (e.g., 301); a circuit board (e.g., 200) configured to be disposed on the base (e.g., 300); and an electrical connector comprising: a housing (e.g., 1) comprises a cavity (e.g., 16), a plurality of terminals (e.g., 3), each of the plurality of terminals (e.g., 3) comprising a mating end disposed in the cavity (e.g., 16) of the housing (e.g., 1), and a contact tail mounted to the circuit board (e.g., 200), and a fixing member (e.g., 2) comprising a first portion (e.g., 22) fixedly held by the housing (e.g., 1), and a second portion (e.g., 23) configured to engage the supporting arm (e.g., 301) of the base (e.g., 300).

10. The electronic system of aspect 9 or any other aspect, wherein: the supporting arm (e.g., 301) of the base (e.g., 300) comprises a groove (e.g., 302); and the housing (e.g., 1) of the electrical connector comprises an arm (e.g., 116) extending outwardly and configured to be fixedly disposed in the groove (e.g., 302) of the supporting arm (e.g., 301) of the base (e.g., 300).

11. The electronic system of aspect 10 or any other aspect, wherein: the second portion (e.g., 23) of the fixing member (e.g., 2) extends through a space between the arm (e.g., 116) and a side (e.g., 11) of the housing (e.g., 1).

12. The electronic system of aspect 11 or any other aspect, wherein: the second portion (e.g., 23) of the fixing member (e.g., 2) comprises a barb (e.g., 231) disposed below the arm (e.g., 116) of the housing (e.g., 1), the barb (e.g., 231) configured to fixedly engage the supporting arm (e.g., 301) of the base (e.g., 300).

13. The electronic system of aspect 12 or any other aspect, wherein: the second portion (e.g., 23) of the fixing member (e.g., 2) comprises a spring arm (e.g., 233) disposed above the arm (e.g., 116) of the housing (e.g., 1), the spring arm (e.g., 233) configured to elastically engage the supporting arm (e.g., 301) of the base (e.g., 300).

14. The electronic system of aspect 9 or any other aspect, wherein: the electrical connector is a first electrical connector comprising a first housing (e.g., 1) and a plurality of first terminals (e.g., 3); and the electronic system comprises a second electrical connector (e.g., 4), the second electrical connector (e.g., 4) comprising: a second housing (e.g., 41) comprising a mating portion (e.g., 412) and a rear portion (e.g., 413), a plurality of second terminals (e.g., 44), each of the plurality of second terminals (e.g., 44) comprising a second mating end held in the mating portion (e.g., 412) of the second housing (e.g., 41) and configured to engage a first mating end of a respective first terminal (e.g., 3) of the first electrical connector, and a second contact tail configured for cable termination, a first sealing member (e.g., 42) surrounding the mating portion (e.g., 412) of the second housing (e.g., 41), and a second sealing member (e.g., 43) disposed in the second housing (e.g., 41) and configured to surround cable terminations.

15. The electronic system of aspect 14 or any other aspect, wherein: the first housing (e.g., 1) of the first electrical connector comprises a protrusion (e.g., 115) protruding outwardly from a side (e.g., 11); and the second housing (e.g., 41) of the second electrical connector (e.g., 4) comprises a lever (e.g., 4111) disposed outside the mating portion (e.g., 412), the lever (e.g., 4111) comprising an opening (e.g., 41111) configured to receive the protrusion (e.g., 115) of the first electrical connector.

16. A method of operating an electrical connector, the electrical connector comprising a housing (e.g., 1), a plurality of terminals (e.g., 3) each having a mating end and a contact tail, and a fixing member (e.g., 2) having a first portion (e.g., 22) fixedly held by the housing (e.g., 1) and a second portion (e.g., 23) elastically connected to the housing (e.g., 1), the method comprising: surface mounting the contact tails of the plurality of terminals (e.g., 3) of the electrical connector on respective contact pads of a circuit board (e.g., 200) disposed on a base (e.g., 300); and engaging the second portion (e.g., 23) of the fixing member (e.g., 2) with a supporting arm (e.g., 301) of the base (e.g., 300) so as to secure the connector to the circuit board (e.g., 200).

17. The method of aspect 16 or any other aspect, wherein engaging the second portion (e.g., 23) of the fixing member (e.g., 2) with the supporting arm (e.g., 301) of the base (e.g., 300) comprises: inserting a barb (e.g., 231) of the second portion (e.g., 23) of the fixing member (e.g., 2) into a slit (e.g., 3011) of the supporting arm (e.g., 301) of the base (e.g., 300).

18. The method of aspect 16 or any other aspect, wherein engaging the second portion (e.g., 23) of the fixing member (e.g., 2) with the supporting arm (e.g., 301) of the base (e.g., 300) comprises: deforming a spring arm (e.g., 233) of the second portion (e.g., 23) of the fixing member (e.g., 2) with the supporting arm (e.g., 301) of the base (e.g., 300).

19. The method of aspect 16 or any other aspect, comprising: disposing an arm (e.g., 116) of the housing (e.g., 1) that is around the second portion (e.g., 23) of the fixing member (e.g., 2) into a complementary-shaped groove (e.g., 302) of the supporting arm (e.g., 301) of the base (e.g., 300).

20. The method of aspect 16 or any other aspect, comprising: inserting a mating portion (e.g., 412) of a cable connector (e.g., 4) into the housing (e.g., 1) of the connector, the cable connector comprising a housing (e.g., 41) having a mating portion (e.g., 412) and a rear portion (e.g., 413), and a lever connected to the housing and extending across the mating portion and the rear portion of the housing, wherein inserting the mating portion of the cable connector comprises engaging the lever (e.g., 4111) with a protrusion (e.g., 115) protruding outwardly from a side of the connector.

21. A connector disposed on a circuit board (e.g., 200), comprising: a first housing (e.g., 1) and a fixing member (e.g., 2), wherein: the first housing (e.g., 1) comprises a pair of sides (e.g., 11) oppositely disposed in a horizontal direction, and a first end (e.g., 12) and a second end (e.g., 13) oppositely disposed in a longitudinal direction, the side (e.g., 11) comprising a holder (e.g., 111) and a receiving space (e.g., 112); and the fixing member (e.g., 2) comprises a connecting portion (e.g., 21), a first portion (e.g., 22) and a second portion (e.g., 23) disposed at opposite sides of the connecting portion (e.g., 21), the first portion (e.g., 22) inserted into the receiving space (e.g., 112), the connecting portion (e.g., 21) abutting against the holder (e.g., 111), the second portion (e.g., 23) elastically connected to the side (e.g., 11), and the second portion (e.g., 23) comprising a barb (e.g., 231), the second portion (e.g., 23) configured to snap-connect to a supporting arm (e.g., 301) of a base (e.g., 300) where the circuit board (e.g., 200) is mounted through the barb (e.g., 231), thereby connecting the connector and the base (e.g., 300).

22. The connector of aspect 21 or any other aspect, wherein: the first housing (e.g., 1) comprises an arm (e.g., 116) on the side (e.g., 11) and extending towards the base (e.g., 300), the arm (e.g., 116) configured to be inserted into a groove (e.g., 302) of the base (e.g., 300).

23. The connector of aspect 22 or any other aspect, wherein: the first housing (e.g., 1) comprises a bottom (e.g., 14) and a top (e.g., 15) disposed along a height direction; the bottom (e.g., 14), the top (e.g., 15), the second end (e.g., 13) and the sides (e.g., 11) bound a cavity (e.g., 16) with an opening; the barb (e.g., 231) is disposed on a side of the second portion (e.g., 23) away from the cavity (e.g., 16); the second portion (e.g., 23) is bent at its end to form a guiding portion (e.g., 232) disposed on a side of the second portion (e.g., 23) adjacent to the cavity (e.g., 16); and the supporting arm (e.g., 301) comprises a slit (e.g., 3011), and the barb (e.g., 231) is snap-connected into the slit (e.g., 3011).

24. The connector of aspect 23 or any other aspect, wherein: the connector comprises a first terminal (e.g., 3), with one end of the first terminal (e.g., 3) soldered to the circuit board (e.g., 200), and the other end extending from the second end (e.g., 13) into the cavity (e.g., 16).

25. The connector of aspect 23 or any other aspect, wherein: the connecting portion (e.g., 21) is a C-shaped or U-shaped structure, and a length of the second portion (e.g., 23) is greater than a length of the first portion (e.g., 22); the second portion (e.g., 23) comprises a spring arm (e.g., 233), and a protruding height of the spring arm (e.g., 233) is equal to or less than a protruding height of the barb (e.g., 231); and a distance between the barb (e.g., 231) and the bottom (e.g., 14) is greater than a distance between a bottom surface of the arm (e.g., 116) and the bottom (e.g., 14).

26. The connector of aspect 21 or any other aspect, wherein: the side (e.g., 11) comprises a block (e.g., 113) protruding towards the second portion (e.g., 23), and a gap (e.g., 114) between the block (e.g., 113) and the second portion (e.g., 23).

27. A connector assembly, comprising: the connector of any one of aspects 21-26, and a mating connector (e.g., 4) mated with the connector through the first end (e.g., 12).

28. The connector assembly of aspect 27 or any other aspect, wherein the mating connector (e.g., 4) comprises: a second housing (e.g., 41) comprising a pair of sides (e.g., 411) oppositely disposed in the horizontal direction, and a mating end (e.g., 412) and a rear end (e.g., 413) oppositely disposed in the longitudinal direction, the rear end (e.g., 413) configured for connecting to a cable (e.g., 4131); a first sealing member (e.g., 42) surrounding the mating end (e.g., 412); and a second sealing member (e.g., 43) wrapping the cable (e.g., 4131) and connected to the rear end (e.g., 413) in an embedding manner.

29. The connector assembly of aspect 28 or any other aspect, wherein: the side (e.g., 411) comprises a lever (e.g., 4111) disposed outside the mating end (e.g., 412) and comprising an opening (e.g., 41111); and the side (e.g., 11) comprises, near the first end (e.g., 12), a protrusion (e.g., 115) configured to be snap-connected into the opening (e.g., 41111).

30. The connector assembly of aspect 28 or any other aspect, wherein: the mating connector (e.g., 4) further comprises a second terminal (e.g., 44) configured to electrically connect with the first terminal (e.g., 3).

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a housing comprises a top, a bottom, a side, a holder extending from the side, and a receiving space between the side and the holder;
a plurality of terminals held by the housing, each of the plurality of terminals comprising a mating end configured to mate with complementary terminals of a mating connector, and a contact tail configured to mount to a circuit board; and
a fixing member comprising a first portion disposed in the receiving space of the side of the housing, a second portion, a connecting portion between the first portion and the second portion and abutting against the holder of the side of the housing, the second portion extending beyond the bottom of the housing and configured to fixedly connect to a base supporting the circuit board.

2. The electrical connector of claim 1, wherein:
the contact tail of each of the plurality of terminals is configured to surface mount on the circuit board.

3. The electrical connector of claim 1, wherein:
the housing comprises an arm extending from the side and around the second portion of the fixing member.

4. The electrical connector of claim 3, wherein:
the arm of the housing is configured to be inserted into a groove of the base.

5. The electrical connector of claim 3, wherein:
the connecting portion of the fixing member is C-shaped or U-shaped.

6. The electrical connector of claim 5, wherein:
the second portion of the fixing member comprises a spring arm protruding away from the side of the housing, and a barb protruding to a same extent as or beyond the spring arm, the barb disposed farther from the bottom of the housing than a bottom surface of the arm of the housing.

7. The electrical connector of claim 6, wherein:
the barb of the second portion of the fixing member is configured to engage a supporting arm of the base.

8. The electrical connector of claim 4, wherein:
the housing comprises a block protruding from the side toward the second portion of the housing, a gap between the block of the housing and the second portion of the fixing member, and a protrusion protruding from the side and closer to a mating face of the electrical connector than the block, the protrusion configured to engage a lever of the mating connector.

9. An electronic system comprising:
a base comprising a supporting arm;
a circuit board configured to be disposed on the base; and
an electrical connector comprising:
a housing comprises a cavity,
a plurality of terminals, each of the plurality of terminals comprising a mating end disposed in the cavity of the housing, and a contact tail mounted to the circuit board, and
a fixing member comprising a first portion fixedly held by the housing, and a second portion configured to engage the supporting arm of the base.

10. The electronic system of claim 9, wherein:
the supporting arm of the base comprises a groove; and
the housing of the electrical connector comprises an arm extending outwardly and configured to be fixedly disposed in the groove of the supporting arm of the base.

11. The electronic system of claim 10, wherein:
the second portion of the fixing member extends through a space between the arm and a side of the housing.

12. The electronic system of claim 11, wherein:
the second portion of the fixing member comprises a barb disposed below the arm of the housing, the barb configured to fixedly engage the supporting arm of the housing.

13. The electronic system of claim 12, wherein:
the second portion of the fixing member comprises a spring arm disposed above the arm of the housing, the spring arm configured to elastically engage the supporting arm of the housing.

14. The electronic system of claim 9, wherein:
the electrical connector is a first electrical connector comprising a first housing and a plurality of first terminals; and
the electronic system comprises a second electrical connector, the second electrical connector comprising:
a second housing comprising a mating portion and a rear portion,
a plurality of second terminals, each of the plurality of second terminals comprising a second mating end held in the mating portion of the second housing and configured to engage a first mating end of a respective first terminal of the first electrical connector, and a second contact tail configured for cable termination,
a first sealing member surrounding the mating portion of the second housing, and
a second sealing member disposed in the second housing and configured to surround cable terminations.

15. The electronic system of claim 14, wherein:
the first housing of the first electrical connector comprises a protrusion protruding outwardly from a side; and
the second housing of the second electrical connector comprises a lever disposed outside the mating portion, the lever comprising an opening configured to receive the protrusion of the first electrical connector.

16. A method of operating an electrical connector, the electrical connector comprising a housing, a plurality of terminals each having a mating end and a contact tail, and a fixing member having a first portion fixedly held by the housing and a second portion elastically connected to the housing, the method comprising:
surface mounting the contact tails of the plurality of terminals of the electrical connector on respective contact pads of a circuit board dispose on a base; and
engaging the second portion of the fixing member with a supporting arm of the base so as to secure the connector to the circuit board.

17. The method of claim 16, wherein engaging the second portion of the fixing member with the supporting arm of the base comprises:
inserting a barb of the second portion of the fixing member into a slit of the supporting arm of the base.

18. The method of claim 16, wherein engaging the second portion of the fixing member with the supporting arm of the base comprises:
deforming a spring arm of the second portion of the fixing member with the supporting arm of the base.

19. The method of claim 16, comprising:
disposing an arm of the housing that is around the second portion of the housing into a complementary-shaped groove of the supporting arm of the base.

20. The method of claim 16, comprising:
inserting a mating portion of a cable connector into the housing of the connector, the cable connector comprising a housing having a mating portion and a rear portion, and a lever connected to the housing and extending across the mating portion and the rear portion of the housing,
wherein inserting the mating portion of the cable connector comprises engaging the lever with a protrusion protruding outwardly from a side of the connector.
